(19) United States
(12) Patent Application Publication
(10) Pub. No.: US 2012/0013852 A1
(43) Pub. Date: Jan. 19, 2012

(54) Alternating Beam Laser Imaging System with Reduced Speckle

(75) Inventors: Mark Champion, Kenmore, WA (US); Mark O. Freeman, Snohomish, WA (US); Alban N. Lescure, Redmond, WA (US); Markus Duelli, Seattle, WA (US)

(73) Assignee: MICROVISION, INC., Redmond, WA (US)

(21) Appl. No.: 12/835,037

(22) Filed: Jul. 13, 2010

(51) Int. Cl. G02B 27/48; G02B 26/10; G03B 21/14

(52) U.S. Cl. 353/31; 359/204.3

(57) ABSTRACT

An imaging system (200) is configured to reduce perceived speckle in images (201) produced by the imaging system. The imaging system (200) includes one or more laser source pairs (205,206), with each laser source pair being configured to produce two beams (209,210) of a color. A spatial light modulator (211) is configured to produce the images (201) with light (212) from the source pairs by scanning the light (212) in a raster pattern (213) along a projection surface (202). A beam translator (225) is configured to cause lines of successive sweeps of the raster pattern (213) to be scanned with the two beams (221,222) on an alternating basis such that a line scanned by a first of the two beams in one sweep is scanned by a second of the two beams in a sequentially subsequent sweep. Other optical elements can introduce angular diversity to further reduce speckle, such as a beam shifter (2200) and a light translation element (990).

### CROSS REFERENCE TO PRIOR APPLICATIONS

This application is related to commonly assigned U.S. application Ser. No. ______, entitled “Laser Scanning Imaging System with Reduced Speckle,” filed concurrently herewith by the same inventors, Attorney Docket No. 09-41, which is incorporated herein by reference for all purposes.

### BACKGROUND

1. Technical Field

This invention relates generally to scanned laser projection systems, and more particularly to a scanned, laser-based system employing alternating beams to scan common lines of an image to introduce wavelength diversity to reduce speckle perceived by a viewer.

2. Background Art

Laser projection devices facilitate the production of brilliant images created with vibrant colors. Laser projection systems are generally brighter, sharper, and have a larger depth of focus than do conventional projection systems. Further, the advent of semiconductor lasers and laser diodes allows laser projection systems to be designed as compact projection systems that can be manufactured at a reasonable cost. These systems consume small amounts of power, yet deliver bright, complex images.

One practical drawback associated with using lasers in projection systems is the image artifact known as “speckle.” Speckle occurs when a coherent light source is projected onto a randomly diffusing projection surface. Laser light is highly coherent. Accordingly, when it reflects off a rough surface, components of the light combine with other components to form patches of higher intensity light and lower intensity light. In a detector with a finite aperture such as a human eye, these varied patches of intensity appear as “speckles,” meaning that some small portions of the image look brighter than other small portions. This spot-to-spot intensity difference can vary depending on observer's position, which makes the speckles appear to change in time when the observer moves.

Turning now to FIG. 1, illustrated therein is a prior art system 100 in which an observer 102 may perceive speckle. Specifically, a coherent light source 101, such as a semiconductor-type or standard laser, delivers a coherent beam 104 to a spatial modulation device 103. The spatial modulation device 103 modulates the coherent beam 104 into a modulated coherent beam 105 capable of forming an image. This modulated coherent beam 105 is then delivered to a projection medium, such as the projection screen 107 shown in FIG. 1.

As the projection screen 107 surface has a random roughness, i.e., as it includes tiny bumps and crevices that are randomly distributed, the reflected light 108 has portions that combine and portions that cancel. As a result, the observer 102 views an image 106 that appears to be speckled. The presence of speckle often tends to perceptibly degrade the quality of the image produced using the laser projection system.

There is thus a need for an improved speckle-reducing system for use with laser-based projection systems such as those employing semiconductor-type lasers.

### BRIEF DESCRIPTION OF THE DRAWINGS

FIG. 1 illustrates a prior art laser projection system.

FIG. 2 illustrates one embodiment of an image projection system in accordance with embodiments of the invention.

FIGS. 3 and 4 illustrate operation of the embodiment of FIG. 2, and can be considered to be steps of a method used to perform speckle reduction in accordance with embodiments of the invention.

FIG. 5 illustrates the concept of pinch in scanned laser systems, a phenomena that can be corrected with beam translators configured in accordance with embodiments of the invention.

FIG. 6 illustrates another image projection system configured in accordance with embodiments of the invention.

FIGS. 7 and 8 illustrate operation of the embodiment of FIG. 6, and can be considered to be steps of a method used to perform speckle reduction in accordance with embodiments of the invention.

FIG. 9 illustrates another image projection system configured in accordance with embodiments of the invention.

FIGS. 10-13 illustrate operation of the embodiment of FIG. 9, and can be considered to be steps of a method used to perform speckle reduction in accordance with embodiments of the invention.

FIGS. 14-19 illustrate embodiments of beam translators and light translation elements configured in accordance with embodiments of the invention.

FIG. 20 illustrates another image projection system configured in accordance with embodiments of the invention.

FIGS. 21-24 illustrate operation of the embodiment of FIG. 20, and can be considered to be steps of a method used to perform speckle reduction in accordance with embodiments of the invention.

FIG. 25 illustrates another image projection system configured in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to an imaging system configured to reduce perceived speckle. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of reducing speckle as described herein. The non-processor circuits may include, but are not limited to, microprocessors, scanning mirrors, image spatial modulation devices, memory devices, clock circuits, power circuits, and so forth.

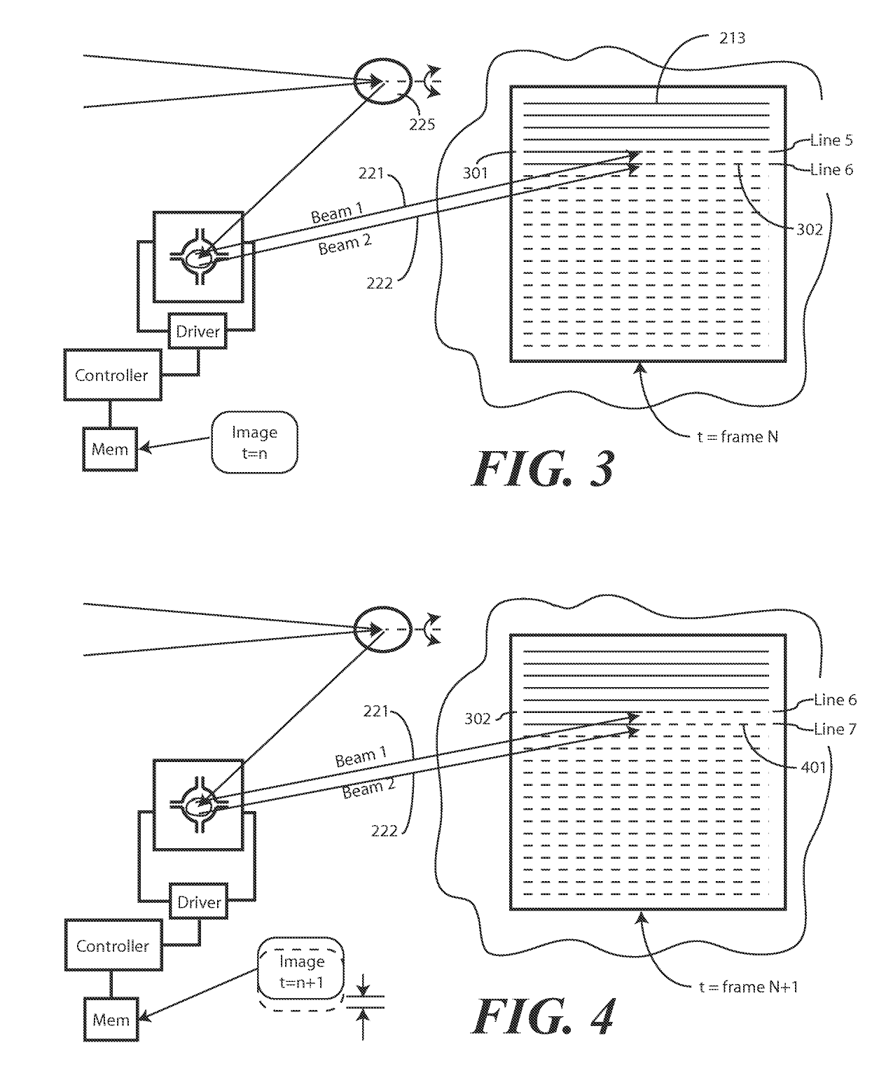

As such, the functions and operative states shown herein, such as those shown in FIGS. 3, 4, 7, 8, 10-13, and 21-24 may be interpreted as steps of a method to perform speckle reduction. Alternatively, some or all functions employed by the one or more processors to control the various elements herein, including the spatial light modulator, beam translator, and light translation element, could be implemented by a state machine that has no stored program instructions, or in one or more application specific integrated circuits, in which each function or some combinations of certain of the functions are implemented as custom logic. Of course, a combination of the two approaches could be used. It is expected that one of ordinary skill, notwithstanding possibly significant effort and many design choices motivated by, for example, available time, current technology, and economic considerations, when guided by the concepts and principles disclosed herein will be readily capable of generating such programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the invention employ a plurality of lasers in a scanned laser system. While a scanned laser system will be described as an illustrative embodiment, it will be clear to those of ordinary skill in the art having the benefit of this disclosure that the configurations and techniques described herein can be extended to other projection systems as well. Further, while two lasers configured in a pair will be used as an illustrative embodiment for description purposes, note that the plurality of lasers could be extended to three, four, five, or more lasers without departing from the spirit and scope of the invention.

The use of two or more lasers in embodiments of the present invention improves images in two ways: first, the user of two or more lasers increases the image resolution. Second, the user of two or more lasers introduces wavelength diversity, and optionally angular diversity, to reduce speckle.

The image resolution of traditional scanned laser systems is limited by the rate at which an image can be scanned. For example, where a system is scanning video with a single laser at 60 Hz, the sweep frequency of the scanner determines how many lines can be written during each scan. If a resonant frequency scanner is employed, the resonant frequency limits how many lines can be scanned during a sweep. However, the use of at least two lasers increases the image resolution in that multiple lines can be written simultaneously. Illustrating by example, the use of two lasers allows twice as many lines to be written, thereby increasing the image resolution.

A second benefit is the reduction of perceived speckle. Embodiments of the present invention employ multiple lasers to introduce wavelength diversity, and in some embodiments angular diversity as well, to reduce speckle in resulting images. Embodiments of the invention employ laser source pairs, i.e., pairs of lasers configured to emit substantially the same color or wavelength, in an alternatingly shifted pattern to scan a raster pattern differently between successive sweeps to reduce speckle. Note the word “substantially” is used because two laser sources of the same color will generally emit light having slightly different wavelengths due to the practical considerations of manufacturing processes and tolerances. Thus, a laser projection source using the colors red, green, and blue to project images will include a laser source pair for each color. In other words, two lasers emit red beams, two emit green, and two emit blue. While the two red lasers each emit red light, the probability of them having the exact same wavelength is small. Embodiments of the invention switch each laser of the laser source pair to introduce wavelength diversity into the projected image.

In one embodiment, each laser of the laser source pair is physically offset from each other within the system. Each laser source pair can be on continuously at the same time. The light from each laser source hits the spatial light modulator at the same location. However, due to each laser source's offset, the resulting angular position in the projection image space of each beam is offset vertically by one line in image space. Each beam scans a line adjacent to the other. From one frame to the next, a beam translator shifts the beams such that a line scanned by the first beam is subsequently scanned by the second beam, thereby introducing wavelength diversity to reduce speckle. The system also improves image resolution by increasing the amount of data that can be written by a given scanner.

In another embodiment, each laser source pair is sufficiently offset that it delivers its beam to a scanning spatial light modulator at a slightly different location. Accordingly, angular diversity is introduced into the system. In some embodiments, a light translation element can also be included to change the light reception location along the spatial light modulator between successive sweeps to create additional angular diversity. Using both wavelength diversity and angular diversity, speckle can be reduced by up to thirty percent in accordance with embodiments of the invention.

The spatial light modulator scans light from each of the laser source pairs according to a predefined scanning trajectory. For simplicity of discussion, a raster pattern will be used as the predefined scanning trajectory in the examples set forth in the figures. It will be clear to those of ordinary skill in the art having the benefit of this disclosure that other scanning trajectories can be used as well. Further, some spatial light modulators described herein approximate traditional raster patterns with sinusoidal approximations due to their physical constructs. It is to be understood that a “raster sweep” includes traditional raster patterns and approximations thereof.

In one embodiment, light from each laser in each laser source pair is used to scan lines of the scanning trajectory in a manner that alternates from sweep-to-sweep. For example, in one illustrative embodiment, one laser can be used to scan the even lines of a raster pattern while the other laser is used to scan odd lines. In a sequentially subsequent sweep, this can be reversed such as the laser used to previously scan even lines is now used to scan odd lines and vice versa. In another embodiment, one laser can scan one half of an image, while the second laser scans the other half. In a sequential sweep, this can be reversed. By making the reversal, regardless of embodiment, wavelength diversity is introduced because each laser of the laser source pair generally will have a slightly different wavelength. The wavelength diversity reduces perceived speckle in the resulting image.

While the preceding paragraph describes some illustrative embodiments that will be used herein for illustration purposes, it will be obvious to those of ordinary skill in the art having the benefit of this disclosure that other “alternating” schemes can be used to introduce wavelength diversity in accordance with embodiments of the invention.

Note that in the examples that follow, for illustrative purposes many have this reversal occurring in sequentially successive sweeps or frames. While this increases the amount of speckle reduction, it is to be understood that reversing the beams at least once in any set of sweeps capable of perceptible integration by a viewer is required. For example, one embodiment could have the beam translator configured to cause lines of one of every three successive sweeps to be drawn by an alternating beam, rather than causing the change on a sweep-to-sweep basis. In another embodiment, where the refresh rate was sufficiently high, the beam translator could be configured to change beams in sets of two frames, such that one beam draws even lines for two frames and odd lines for two frames. In another embodiment, the beam translator could be configured to change beams for one of every three or four frames, and so forth.

When the beam translator is operative, video content delivered to the amplitude modulator is altered to keep the image stable. For example, where a first beam of a laser source pair switched from scanning even lines to scanning odd lines, that beam is effectively moved down a line or pixel in the image. Similarly, the second beam is shifted. The image data fetched from memory must be correspondingly altered so that the proper beams scan their corresponding lines. This can be done in hardware or firmware in the processor controlling the spatial light modulator. Illustrating by example, in one embodiment, this is accomplished by changing which pixel data is delivered to each laser source. When the beams are shifted, the data selected for delivery to each laser source is chosen so as to keep the image stable. In this method, the data stored in memory does not change, but the selection of which data changes based upon the amount of shift along the projection surface. Said differently, the data delivered to each laser source is altered such that the scanned image remains stable and in focus.

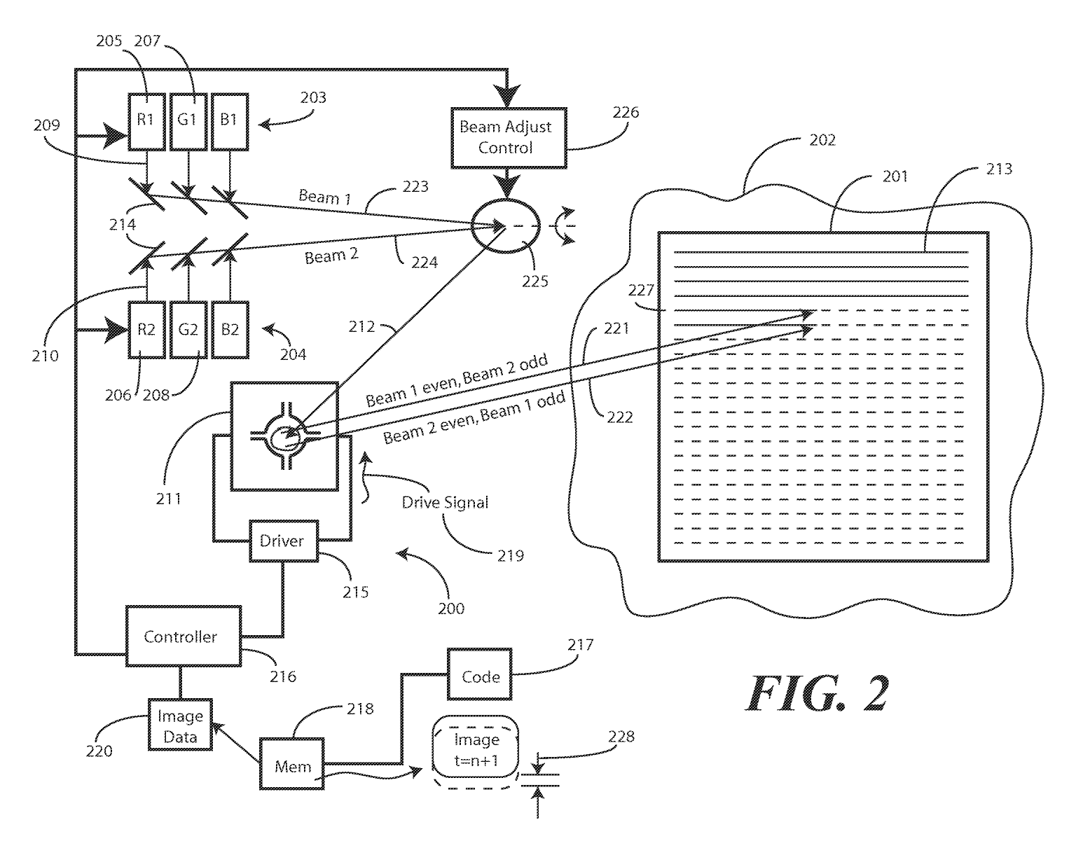

Turning now to FIG. 2, illustrated therein is one imaging system 200 configured to reduce perceived speckle, as well as increase image resolution, in images 201 projected on a projection surface 202 in accordance with one illustrative embodiment of the invention. The imaging system 200 of FIG. 2 includes one or more laser sources 203,204. The one or more laser sources 203,204 are grouped in pairs according to color. In this embodiment, the imaging system employs the colors red, green, and blue to create images 201. Other combinations could be used as well.

Illustrating by example, a first red laser 205 and a second red laser 206 form a first laser source pair. Similarly, a first green laser 207 and a second green laser 208 form a second laser source pair. Each laser source pair is configured to produce two beams 209,210 of substantially the same color or wavelength. As noted above, due to manufacturing tolerances, the probability of the two beams 209,210 having precisely the same wavelength is very small. Each pixel of the image 201 can be displayed with a combination of the two beams 209,210, or by one or the other of the two beams 209,210 individually. These lasers can be various types of lasers, including semiconductor lasers such as edge-emitting lasers or vertical cavity surface emitting lasers. Such semiconductor lasers are well known in the art and are commonly available from a variety of manufacturers.

Depending upon architecture, one or more optical alignment devices 214 can be used to direct light beams from the laser sources 203,204 to other optical components within the system. The optical alignment devices 214 can also be used to orient the light beams 209,210 from the various laser sources into a single light beams as well. Dichroic mirrors can be used as the optical alignment devices 214. Dichroic mirrors are partially reflective mirrors that include dichroic filters that selectively pass light in a narrow wavelength bandwidth while reflecting others. Note that the location, as well as the number, of the optical alignment devices 214 can vary based upon application.

A spatial light modulator 211 is configured to produce the images 201 with light from the laser source pairs. In one embodiment, the spatial light modulator 211 accomplishes this by scanning the light with a predetermined trajectory along the projection surface 202. In this illustrative embodiment the predetermined trajectory is that of a raster pattern 213. Note that the configuration of FIG. 2 is included for illustration and discussion purposes to aid in understanding of embodiments of the invention. It will be clear to those of ordinary skill in the art having the benefit of this disclosure that other configurations of laser projection systems can be used in accordance with embodiments of the invention without departing from the spirit and scope of the invention.

In one embodiment, the spatial light modulator 211 is a microelectromechanical (MEMS) scanning mirror, such as those manufactured by Microvision, Inc. of Redmond, Wash. Examples of MEMS scanning mirrors, such as those suitable for use with embodiments of the present invention, are set forth in commonly assigned, copending U.S. pat. appln. Ser. No. 11/786,423, filed Apr. 10, 2007, entitled, “Integrated Photonics Module and Devices Using Integrated Photonics Module,” which is incorporated herein by reference, and in US Pub. Pat. Appln. No. 10/984,327, filed Nov. 9, 2004, entitled “MEMS Device Having Simplified Drive,” which is incorporated herein by reference. A MEMS spatial light modulator is well suited to embodiments of the invention due to its compact construction, cost effectiveness, and reliability. While a MEMS device will be used herein for discussion purposes, it will be clear to those of ordinary skill in the art having the benefit of the disclosure that other scanning platforms may be used as well.

The spatial light modulator 211 is responsive to a driver 215 and a controller 216. The controller 216 can comprise one or more processors that execute instructions 217 stored in a corresponding memory 218. The controller 216 and driver 215, in one embodiment are configured to deliver a drive signal 219 to the spatial light modulator 211. The drive signal 219 represents amplitude modulation data 220 from information stored in memory 218 and retrieved by the controller 216. The drive signal 219 causes the spatial light modulator 211 to scan the image 201 in accordance with a predetermined resolution comprising a number and arrangement of pixels for which the system has been configured. This resolution will be greater than prior art systems in that two or more lasers are used to write different parts of the image simultaneously and, as such, more information can be written at a given scan rate.

A corresponding drive signal 299 is delivered to the laser sources 203,204. The corresponding drive signal 299 is used to modulate the amplitudes of the laser sources 203,204. Drive signal 219 and corresponding drive signal 299 are synchronized to control the laser sources 203,204 and spatial light modulator 211 to steer the light beam 212 in the proper direction with proper amplitude for each pixel of the predetermined resolution.

In one embodiment, the driver 215 is operative to pivot the spatial light modulator 211 about a first axis and second axis by delivering a control signal to the spatial light modulator 211. This pivoting action causes the scanned light 221,222 to move horizontally and vertically, in one embodiment, in a raster pattern 213 to form the image 201. The raster pattern 213 is “refreshed,” i.e., it is re-swept across the image 201 to re-draw the image 201 at an image refresh cycle. Common refresh rates are 60 Hz and 100 Hz, although others can be used.

When drawing images, the driver 215 can cause the spatial light modulator 211 to sweep the scanned light 221,222 to form an image 201 that corresponds with image data 220 stored in the memory 218. For example, where the image data 220 is video content, each raster scan can comprise a frame of video. Where the image data 220 is a still image, each raster scan may refresh the image by redrawing it.

As noted above, speckle reduction is achieved by shifting a first beam 223 and a second beam 224 emitted by each laser source pair between successive sweeps or within sets of sweeps. For example, where the first beam 223 is used to scan even lines of the raster pattern 213 during one sweep, with the second beam 224 being used to scan odd lines, the beams can be shifted between sweeps such that in the sequentially subsequent sweep the first beam 223 is used to scan odd lines with the second beam 224 scanning even lines. This introduces wavelength diversity into the scanned beams 221,222, thereby reducing speckle.

In another embodiment, rather than shifting the beams every frame, only certain frames within optically integratable groups may be shifted. For example, the beams may be shifted for one sweep in three, two sweeps in four, three sweeps in four, and so forth. Where images are presented by a sweeping raster pattern, the human eye averages successive sweeps. Studies suggest that the human eye has an integration time of approximately 50-60 milliseconds. Beyond this range, the eye will perceive visible artifacts such as flicker. Thus, when images change in a shorter period of time, the artifacts will not be noticed. However, when they change across a longer period of time, artifacts may be noticed. Accordingly, using standard refresh rates of 60 Hz and to 100 Hz, in one embodiment the beams are shifted such that lines swept during any 50-60 millisecond period are comprised of lines scanned by both first beam 223 and second beam 224 two sweeps of any from four consecutive sweeps have a line that is scanned by a first beam 223 in one sweep and a second beam 224 in another sweep. While various combinations of frames and beam shifting will each reduce speckle, experimental testing has shown that shifting the first beam 223 and the second beam 224 such that they are scanning for approximately equal amounts of time in any given set of frames works to optimized speckle reduction. In general terms, when N beams are employed, speckle reduction is enhanced when each beam scans a corresponding image area for the time of one sweep divided by N. Thus, in a two-laser embodiment, scanning every other line with a different beam, or every other frame with a different beam, provides more speckle reduction than does scanning one of every three lines or frames with a different beam.

The beam shifting can be accomplished in a variety of ways. In one embodiment, the beams are shifted by a beam translator 225, which can be configured as an electromechanically movable mirror. Concurrently with shifting the beams, the video data is redirected so as to send the proper information to the proper laser group such that no shifting of information occurs in scanned image 201.

The beam translator 225 is responsive to a beam adjust control driver 226, which is operable with the controller 216. Control signals from the beam adjust control driver 226 cause the beam translator 225 to pivot, thereby altering the reflection of the first beam 223 and second beam 224 to the spatial light modulator 211. In so doing, the beam translator 225 can function as a beam selector in that it can determine which beam will scan which line of the raster pattern 213.

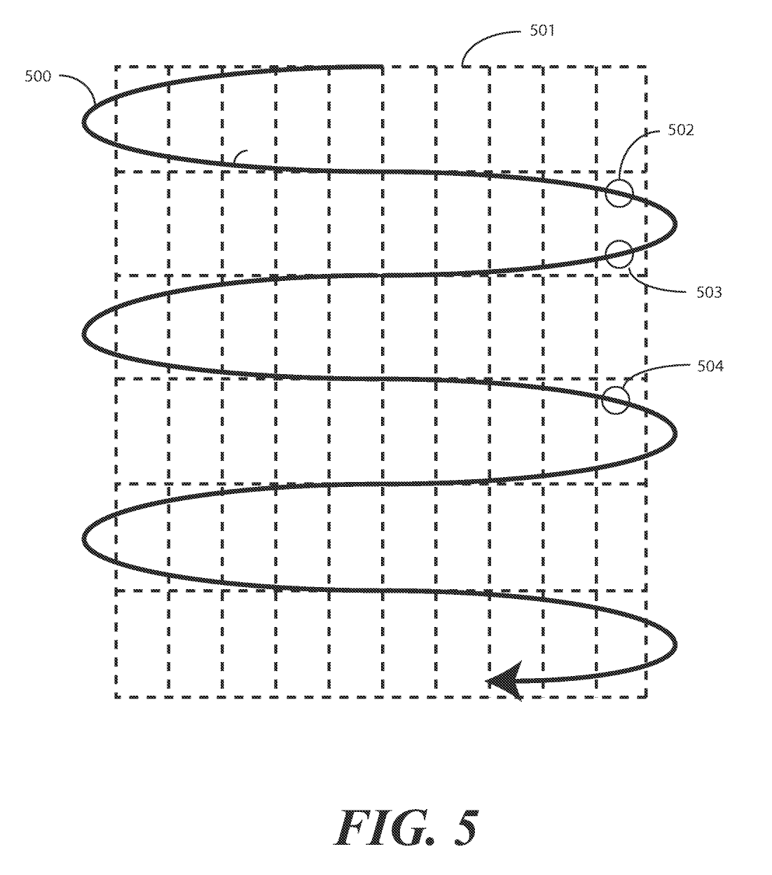

In one embodiment, the beam translator 225 can serve a dual function. In addition to reducing speckle as described herein, the beam translator 225 can perform pinch correction as well. Turning briefly to FIG. 5, illustrated therein is a graphical representation of “pinch” as the term is used in scanned laser image projection systems. Pinch is also described in commonly assigned US Published Patent Application No. 2008/0114150, filed Feb. 18, 2010, entitled “Projection System with Multi-Phased Scanning Trajectory,” which is incorporated herein by reference.

In another embodiment, the drive signal 219 being delivered to the spatial light modulator 211 is reconfigured to cause the shifting to occur. For example, the drive signal 219 can be biased to move the spatial light modulator 211 in the vertical direction, thereby shifting beams 221,222 along the projection surface 202 to introduce the angular diversity. In this configuration, the spatial light modulator 211 and beam translator 225 are configured as a single device working with a biased drive signal 219. As set forth in the claims below, in this embodiment the “beam translator” comprises the spatial light modulator's operation in response to the biased drive signal 219.

As noted above, when scanning a raster pattern (213), traditional trajectories of straight lines and rows can be created. Alternatively, trajectories approximating raster patterns can be used. Where a MEMS device is used as the spatial light modulator (211), the physical construction of the device will result in an approximate raster pattern 500, which is shown in FIG. 5.

In FIG. 5, the approximate raster pattern 500 is created by a sinusoidal horizontal scan trajectory and a linear vertical trajectory. For illustration purposes, this “practical” raster waveform is superimposed upon a grid 501 representing an ideal raster pattern. The ideal rows are shown as horizontal dashed lines, with vertical spacing shown along the vertical dashed lines.

The vertical sweep rate, also called the “slow scan” rate, is typically set such that the number of horizontal sweeps equals the number of rows in the grid. The vertical scan position at any time is approximated as a corresponding row. The horizontal sweep rate, also called the “fast scan” rate is then set such that each sweep of the image syncs with the refresh rate.

In the approximate raster pattern 500, the horizontal fast-scan lines are not parallel to each. This creates an image artifact referred to as “raster pinch”. Raster pinch is shown in FIG. 5 where pixels 502 and 503 are more closely spaced, i.e., they are “pinched,” when compared with pixels 503 and 504.

Turning now back to FIG. 2, the beam translator 225 can be used not only to reduce speckle by shifting beams, but can also correct pinch. In one embodiment the beam translator 225 accomplishes both functions when the controller 216 delivers a pinch correction signal to the beam adjust control driver 226 in addition to the speckle reduction control signals and a frame sync signal.

Focusing now on the speckle reduction function, in one embodiment the beam translator 225 is configured to cause lines of successive sweeps of the raster pattern 213 to be scanned with the two beams 221,222. In one embodiment, both beams 221,222 are on at the same time, such that each beam 221,222 scans an adjacent line. This is shown illustratively in FIGS. 3 and 4.

Turning first to FIG. 3, the beam translator 225 is positioned such that beam 221 is scanning odd lines 301 of the raster pattern 213 during a first sweep. Beam 222 can be active at the same time, thereby scanning line 302 simultaneously. Said differently, the two lines 301,302 can be scanned “in parallel.”

The beam translator 225 operates to shift the beams 221,222 along the projection surface between scans. Consequently, in a subsequent scan, beam 222 to scan even lines 302 of the raster pattern 213. This is shown in FIG. 4. Turning now to FIG. 4, the beam translator 225 has shifted the two beams 221,222 such that at a sequentially subsequent sweep, beam 221 scans the even lines 302 and beam 222 scans the odd lines 401. In this illustrative embodiment, this can be accomplished by shifting the beams 221,222 down by one pixel such that the rows scanned are opposite that of FIG. 3.

Turning back to FIG. 2, when this occurs, the control signal 219 and corresponding control signal 299 can be correspondingly adapted 228 to keep the image stable. Said differently, the drive signal 219 can be adjusted such that the proper image information is delivered to the proper laser source 203,204 after operation of the beam translator 225. Accordingly, in one embodiment the controller 216 is configured to adapt 228 the image data pointers 220 to select the proper pixels that correspond with movement of the beams 221,222 by the beam translator 225. This adaptation 228 results in images 201 generated by the successive sweeps of the raster pattern remaining stable along the projection surface 202.

In the illustrative embodiment of FIG. 2, both beams 221,222 effectively fill the surface of the spatial light modulator 211 as they are scanned to form the image 201. When the beams 221,222 are shifted, there is very little shift of either beam 221,222 on the spatial light modulator 211. The change is that one beam writes a line in a subsequent sweep that was written by the other beam. The angle at which each beam is incident on the projection surface 202 remains effectively the same. Speckle reduction in this embodiment occurs primarily due to the difference in wavelength between each laser of the laser source pairs.

While this works well in practice, there can be an anomalous situation in which two lasers in a laser source pair have the same or effectively the same wavelengths. For example, it is conceivable that two lasers in a laser source pair may only have a one or two nanometer or less difference in wavelength. Where this occurs, the speckle created by each beam may be correlated with the other, thereby compromising the amount of speckle reduction that can be achieved.

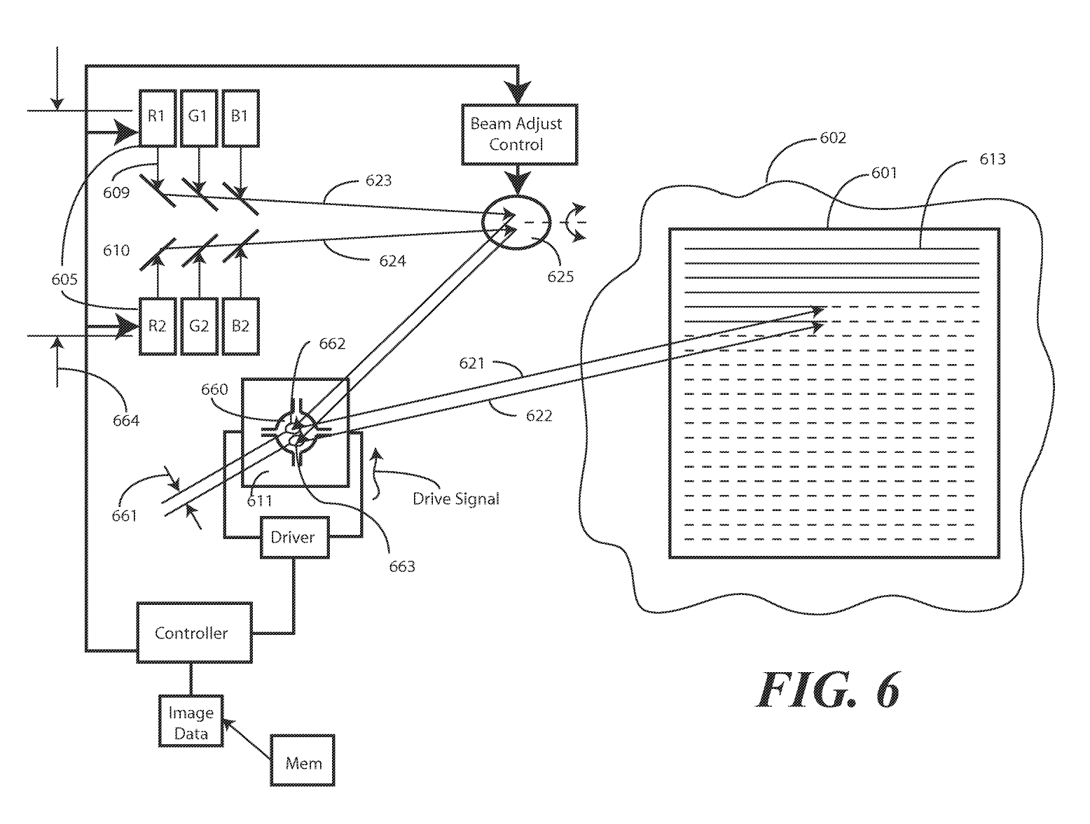

To further enhance speckle reduction in this situation, angular diversity can also be introduced into the system. Turning now to FIG. 6, illustrated therein is another embodiment of a dual beam laser projection system configured in accordance with embodiments of the invention that is designed to reduce speckle by using both wavelength diversity and angular diversity.

Many of the components of FIG. 6 are the same as with FIG. 2. For example at least one laser source pair 605 is configured to deliver two beams 609,610 of each color to a spatial light modulator 611. The spatial light modulator 611, as above, is an electromechanically controllable scanning assembly configured to receive light from the laser source pairs, and to scan the light in substantially a raster pattern 613 to form images 601 on a projection surface 602. As with FIG. 2, the beam translator 625 is configured to cause lines of successive sweeps of the raster pattern 613 to be scanned with two beams 621,622 from the at least one laser source pair on a changing basis such two sweeps, which may be sequentially consecutive, of any set of visibly integratable set of consecutive sweeps have at least one line that is scanned by the first beam 621 in one sweep and the second beam 622 in another sweep.

The embodiment of FIG. 6 differs from that of FIG. 2 in that the beams 623,624 coming from the beam translator 625 are offset 661 on the surface 660 of the spatial light modulator 611. This can be accomplished in a variety of ways, some of which are discussed in more detail below. In one simple embodiment, this can be accomplished by physically offsetting each laser of each laser source pair relative to the beam translator 625. Said differently, each laser 605,606 of each laser source pair 605 can be offset 664 from the other such that a first beam 623 and a second beam 624 arrive on the surface 660 of the spatial light modulator 611 in different locations 662,663.

In the embodiment of FIG. 6, when the beam translator 625 swaps the beams 621,622 between sweeps, the beams 621,622 are now coming from different locations 662,663 on the surface 660 of the spatial light modulator 611. This introduces angular diversity into the projected image 601. Accordingly, any correlation that may exist between the lasers in each laser source pair is reduced due to the offset locations 662,663 of each beam 621,622 on the surface 660 of the spatial light modulator 611.

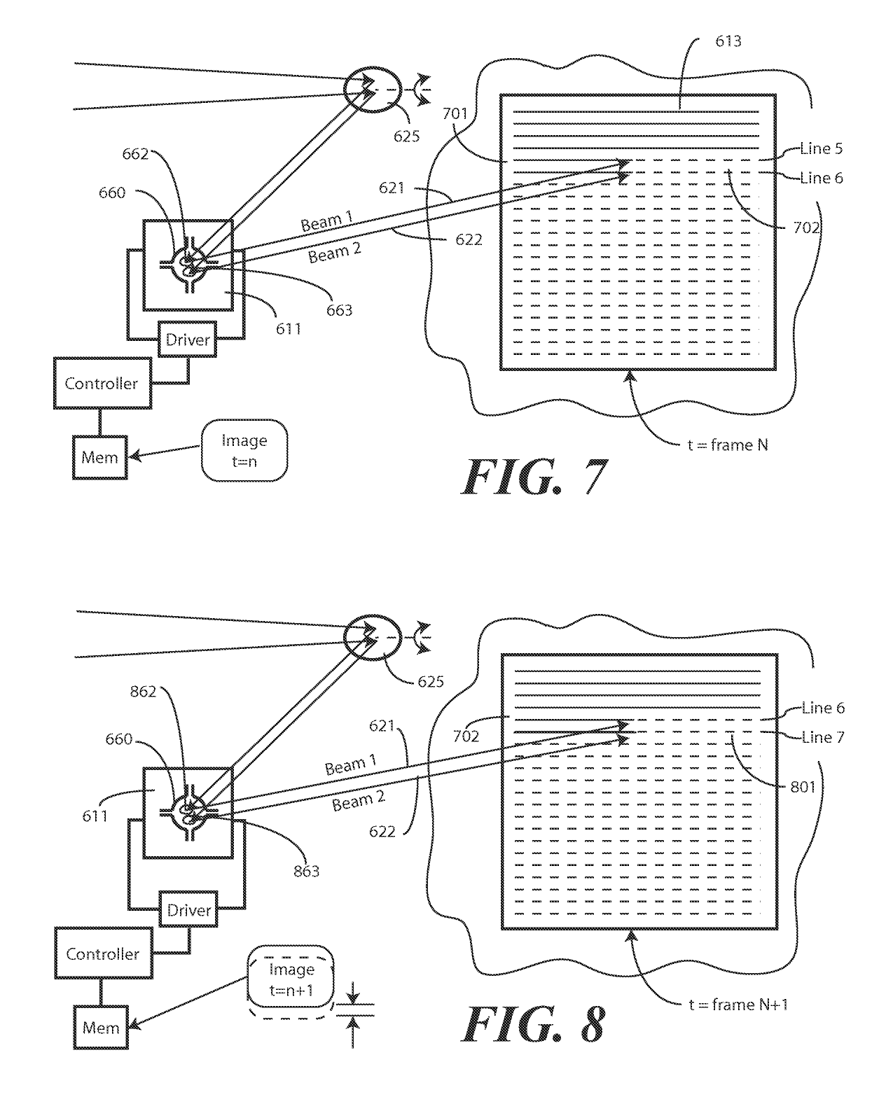

This is shown graphically in FIGS. 7 and 8. Turning first to FIG. 7, the beam translator 625 is positioned such that beam 621 is scanning odd lines 701 of the raster pattern 613 from a first location 662 on the surface 660 of the spatial light modulator 611 during a first sweep. As with FIGS. 3 and 4 above, the beam translator 625 moves between rows of the raster pattern to cause beam 622 to scan even lines 702 of the raster pattern 613. Beam 622 scans those lines from a second location 663 on the surface 660 of the spatial light modulator 611.

Between sweeps, the beam translator 625 shifts the two beams 621,622 such that at a sequentially subsequent sweep, shown in FIG. 8, beam 621 scans the even lines 702 and beam 622 scans the odd lines 801. In shifting the beams 621,622, the location on the surface 600 of the spatial light modulator 611 from which the beams reflect also changes. Beam 621 now scans the even lines 702 from a third location 862 on the surface 600 of the spatial light modulator 611, while beam 622 scans odd lines 801 from a fourth location 863 on the surface 600 of the spatial light modulator 611, thereby introducing angular diversity and reducing perceived speckle.

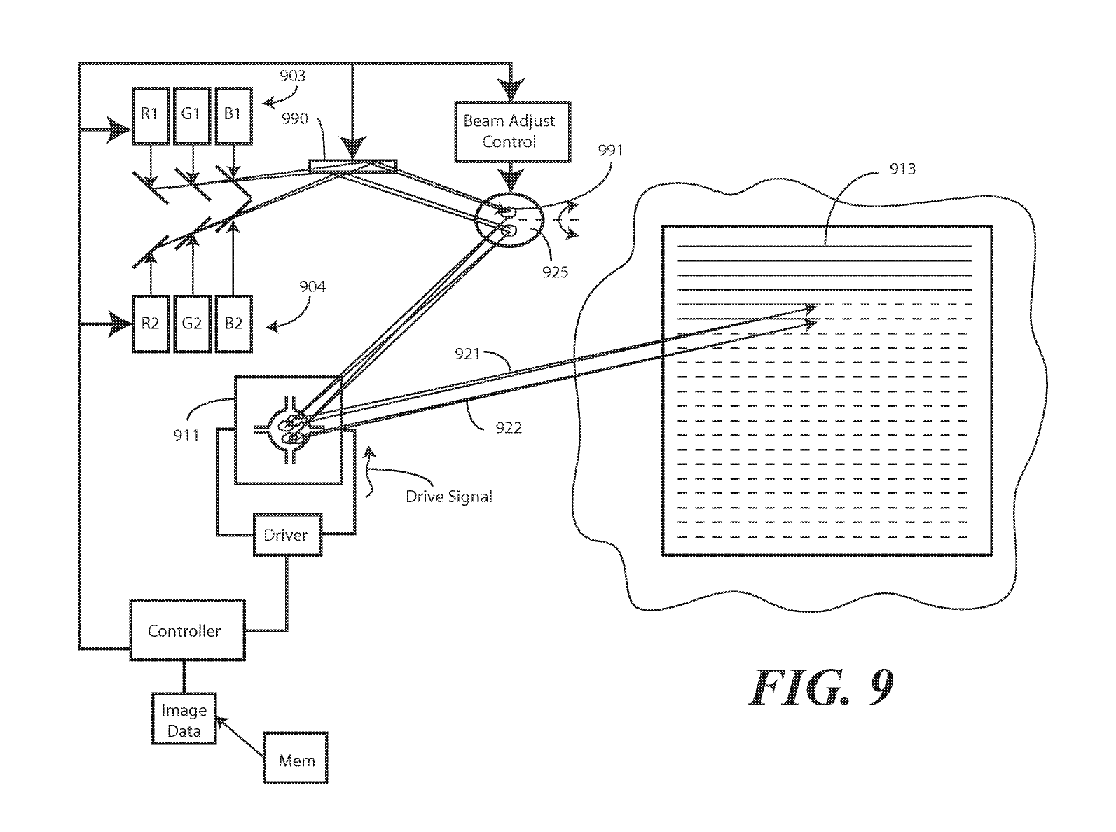

Turning now to FIG. 9, illustrated therein is another embodiment of an imaging system 900 configured to reduce speckle in accordance with embodiments of the invention. The imaging system 900 of FIG. 9 is essentially the same as that of FIG. 6. The primary difference is the inclusion of a light translation element 990 that is configured to introduce additional angular diversity into the system, thereby further reducing perceived speckle.

The light translation element 990 is configured to alter a light reception location within the imaging system 900. In the illustrative embodiment of FIG. 9, the light translation element 990 is disposed between the laser sources 903,904 and the beam translator 925. Accordingly, the light translation element 990 is configured to alter a light reception location 991 along on the beam translator 925. It will be clear to those of ordinary skill in the art having the benefit of this disclosure that the light translation element 990 could be disposed between the beam translator 925 and the spatial light modulator 911 as well. In the latter configuration, the light translation element 990 would be configured to alter a light reception location along on the beam translator 925 rather than on the beam translator 925. Either configuration introduces additional angular diversity into the imaging system 900.

In one embodiment, the light translation element 990 is configured to alter the light reception location between sweeps of the raster pattern 913 such that each beam scanning the lines of the raster pattern 913 alternates between a predetermined set of light reception locations across subsequent sweeps of the raster pattern 913.

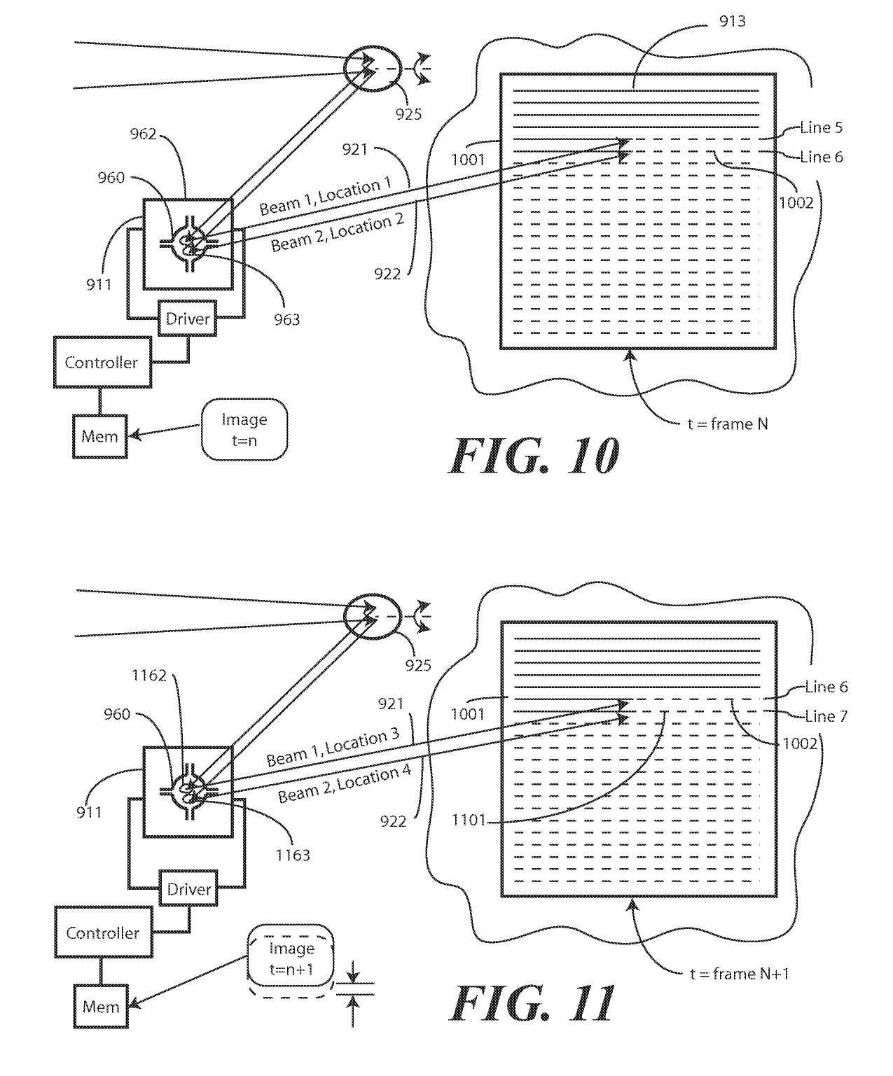

This is shown graphically in FIGS. 10-13. Beginning with FIG. 10, the beam translator 925 is positioned such that beam 921 is scanning odd lines 1001 of the raster pattern 913 from a first location 962 on the surface 960 of the spatial light modulator 911 during a first sweep. The beam translator 925 moves between rows of the raster pattern to cause beam 922 to scan even lines 1002 of the raster pattern 913. Beam 922 scans those lines from a second location 963 on the surface 960 of the spatial light modulator 911. The beams 921,922 are offset at different locations 961,962 on the surface 960 of the spatial light modulator 911.

Between sweeps, the beam translator 925 switches the two beams 921,922 such that at a sequentially subsequent sweep, shown in FIG. 11, beam 921 scans the even lines 1002 and beam 922 scans the odd lines 1101. Due to the initial offset, switching the beams 921,922 causes the locations on the surface 960 of the spatial light modulator 911 from which the beams 921,922 reflect to change as well. Beam 921 now scans the even lines 1002 from a third location 1162 on the surface 960 of the spatial light modulator 911, while beam 922 scans odd lines 1101 from a fourth location 1163 on the surface 960 of the spatial light modulator 911, thereby introducing angular diversity and reducing perceived speckle.

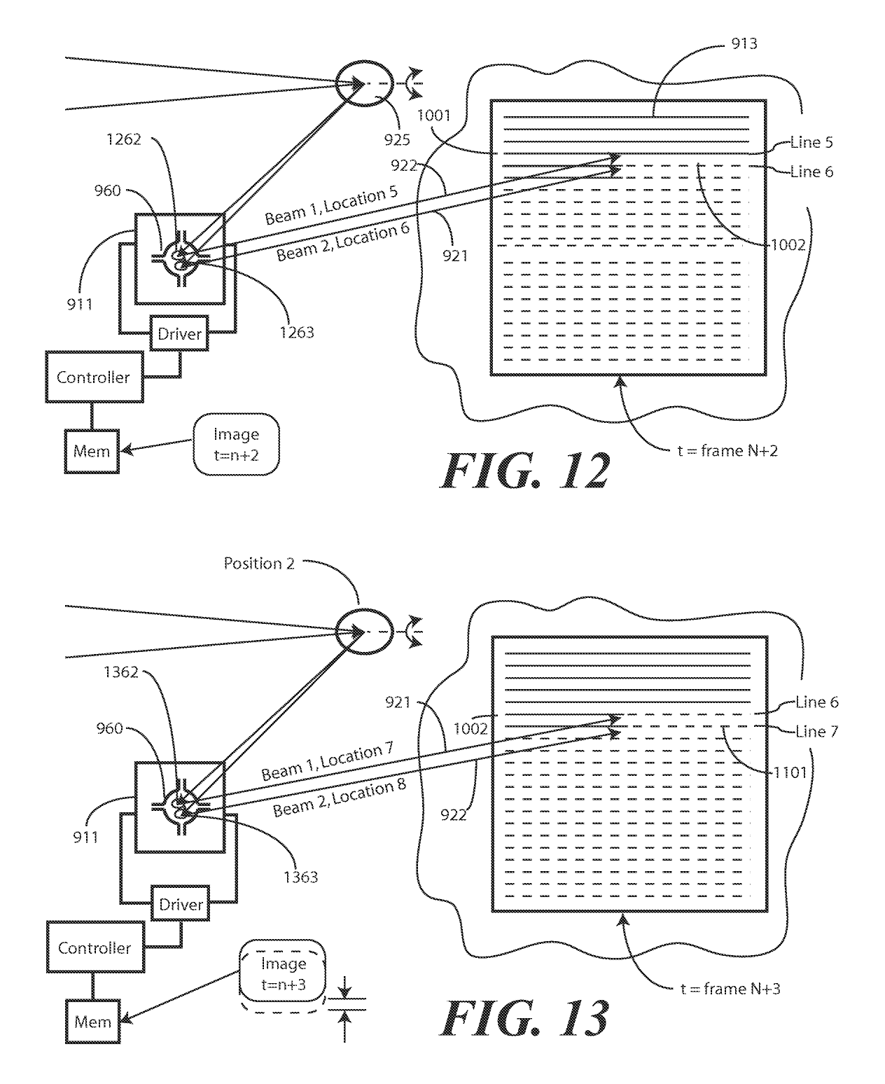

In the transition from FIG. 11 to FIG. 12, two things occur: first, the beam translator 925 toggles back to the state of FIG. 10. Second, the light translation element (990) changes state, thereby translating the light reception locations along the beam translator. As shown in FIG. 12, this results in beam 921 is scanning odd lines 1001 of the raster pattern 913 from a fifth location 1262 on the surface 960 of the spatial light modulator 911 during a third sweep. The beam translator 925 moves between rows of the raster pattern to cause beam 922 to scan even lines 1002 of the raster pattern 913 from a sixth location 1263 on the surface 960 of the spatial light modulator 911.

Between sweeps, the beam translator 925 again switches the two beams 921,922 such that, as shown in FIG. 13, beam 921 scans the even lines 1002 and beam 922 scans the odd lines 1101. Beam 921 now scans the even lines 1002 from a seventh location 1362 on the surface 960 of the spatial light modulator 911, while beam 922 scans odd lines 1101 from an eighth location 1363 on the surface 960 of the spatial light modulator 911.

While the illustrative embodiment of FIGS. 10-13 shows the light translation element (990) moving between two states, it will be clear to those of ordinary skill in the art having the benefit of this disclosure that embodiments of the invention are not so limited. The light translation element (990) can be configured such that the light reception location moves between three or four locations as well.

To this end, in one embodiment, the light translation element (990), examples of which are set forth below, is configured to alter the light reception location in accordance with a predefined pattern. For example, in one embodiment, the light translation element (990) could be configured to alternate the light reception location between a first location and a second location such that some refresh sweeps are made with the light in a first reception location and other refresh sweeps are made with the light in a second reception location. In another embodiment, the light translation element (990) can be configured to alternate between three locations, while another embodiment may rotate between four locations. The number of locations will depend upon the size of the beam translator 925 and the refresh rate. Attention should be paid to the size of the optical surfaces to avoid, for example, light “spilling over” the sides. Attention should be paid to the refresh rate to avoid the introduction of visible artifacts.

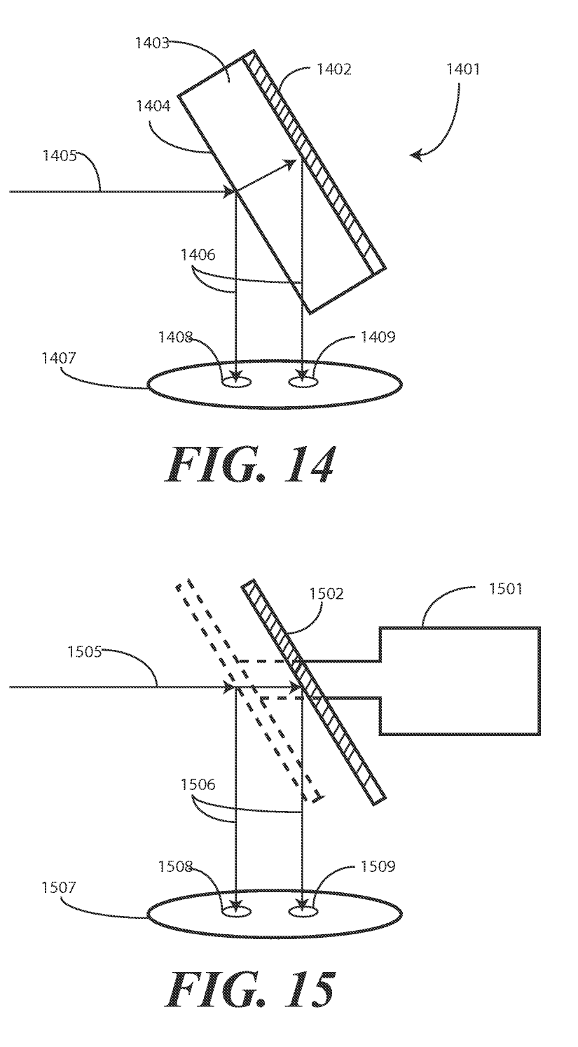

Turning now to FIGS. 14-19, illustrated therein are various exemplary light translation elements (990) suitable for use with embodiments of the invention. The embodiments of FIGS. 15-19 are illustrative only, and are not intended to be limiting. It will be clear to those of ordinary skill in the art having the benefit of this disclosure that other mechanical, electronic, or electromechanical solutions may be substituted.

Beginning with FIG. 14, illustrated therein is an electrically addressable high/low reflectivity layered mirror 1401 suitable for use as a light translation element (990) in accordance with embodiments of the invention. The electrically addressable high/low reflectivity layered mirror 1401 includes a reflective surface 1402 and an layer of optical media 1403 defining an optical path distance or gap. The optical media 1403 can be a simple isotropic material such as glass. The front surface 1404 of the optical media 1403 is configured as an electrically “switchable” material that can be configured to reflect light from the front surface 1404 in a first electrically controllable state, or, in another electrically controllable state, permit the light to pass through the optical media 1403 to the reflective surface 1402. Examples of electrically switchable materials include electronically-addressable Fabry-Perot gap devices or electrically controllable electrochromic layers. When in the first state, incoming light 1405 received from a laser source is reflected from the front surface 1404. In the second state, incoming light 1405 is reflected from the reflective surface 1402. The resulting beam 1406 is delivered to different locations 1408,1409 on the surface of an optical element 1407 in the system.

Turning now to FIG. 15, illustrated therein is an electromechanical solution. Specifically, the light translation element is configured as a mirror 1502 coupled to an electromechanical actuator 1501. In the illustrative embodiment of FIG. 15, the electromechanical actuator 1501 is a piezoelectric transducer. The piezoelectric transducer is configured to move between one of a plurality of positions, thereby selectively altering the physical location of the resulting beam 1506 on an optical element 1507 of the system.

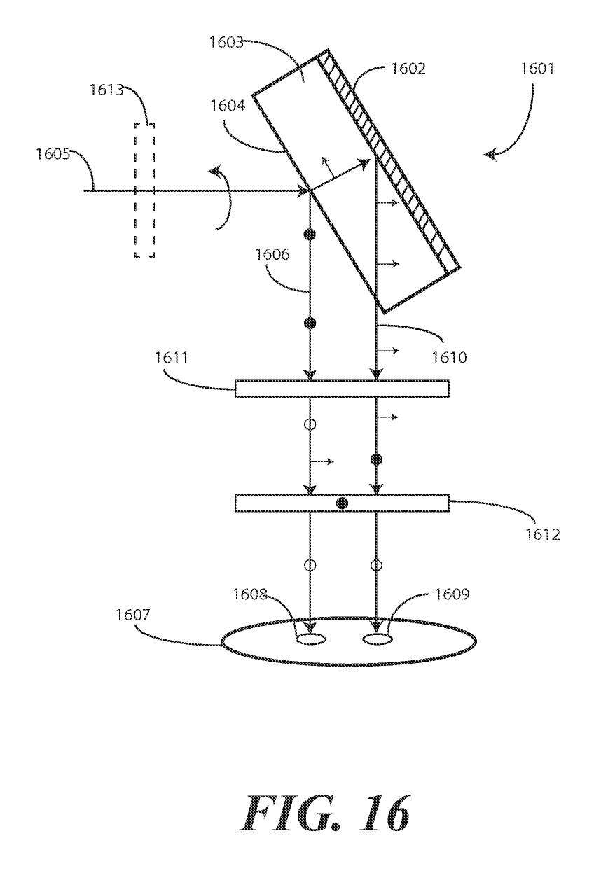

Turning now to FIG. 16, illustrated therein is another embodiment of a light translation element 1601 configured in accordance with embodiments of the invention. In FIG. 16, the light translation element 1601 is configured as a mirror 1602 and polarizing beam splitter 1603 working in tandem. The polarizing beam splitter 1603 separates the received laser beam 1605 into two different polarization beams 1606,1610.

A first polarization beam 1606 is reflected off the front surface 1604 of the polarizing beam splitter 1603 to a first location 1608 on the optical element 1607. The second polarization beam 1610 passes through the polarizing beam splitter 1603 to the mirror 1602. The second polarization beam 1610 therefore reflects to a second location 1609 on the optical element 1607.

The polarization states can be established in multiple ways. For example, in one embodiment, the polarization states of the incoming light can be selectively alternated by an ninety degrees polarization rotator 1613. In another embodiment, the input beam 1605 is circularly polarized or linearly polarized at a forty-five degree angle relative to the polarization axis of the polarizing beam splitter 1603 and a ninety-degree polarization rotator 1611 and polarizer 1612 can be placed in the optical path of each of the first polarization beam 1606 and the second polarization beam 1610 to ensure that each beam again has the same polarization when reflecting off the optical element 1604.

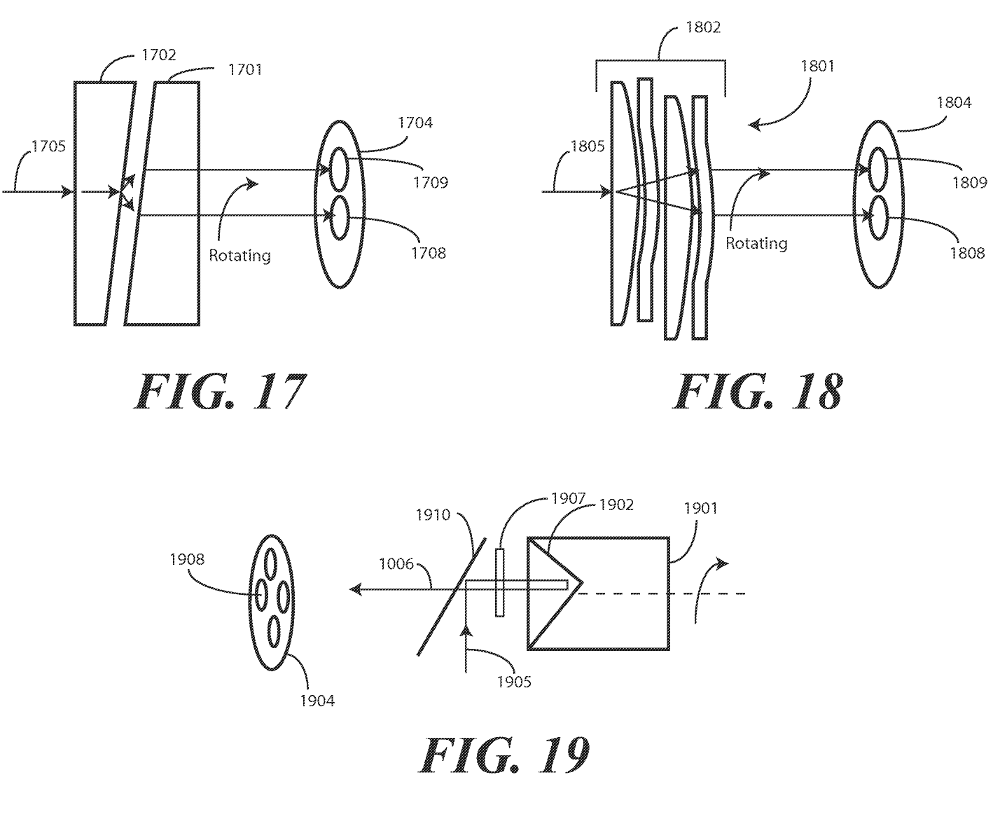

Turning now to FIG. 17, illustrated therein is another embodiment of a light translation element. In FIG. 17, the light translation element comprises a first wedge 1701 and a second wedge 1702. Both wedges are capable of rotation.

As is known in the art, a dual-wedge assembly with an air gap introduces the beam translation. A first wedge 1701 and a second wedge 1702, which may be manufactured from an isotropic material such as glass, are separated by an air gap therebetween. The air gap is responsible for shifting the beam between the first wedge 1701 and second wedge 1702. A designer can tailor the dual-wedge assembly to establish a predetermined amount of translation based upon wedge angles, the air gap, the thickness of the wedges, and index of the wedge material.

By rotating the two-wedge assembly 1701,1702, the optical path of received light 1705 can be altered between multiple locations 1708,1709 on an optical element 1704. One advantage offered by the embodiment of FIG. 16 is that rotation of both wedges 1701,1702 can vary the location of light across many locations on the optical element 1704. Thus, when a designer wants a light translation element that is configured to alternate between three or four locations on the optical element 1704, the embodiment of FIG. 17 makes this easily possible.

Turning now to FIG. 18, illustrated therein is a light translation element 1801 that operates in a manner similar to that shown in FIG. 17. In FIG. 19, a plurality of lenses 1802 is provided, with each lens of the assembly being capable of rotation as a group. By rotating the lenses together, the optical path of received light 1805 across multiple locations 1808,1809 on an optical element 1804. As with the embodiment of FIG. 17, the plurality of lenses 1802 shown in FIG. 18 can vary the location of light across many locations on the optical element 1804.

Turning now to FIG. 19, illustrated therein is yet another light translation element configured in accordance with embodiments of the invention. The light translation element of FIG. 19 is configured as a rotatable optical corner cube 1901 having an off-axis reflective surface 1902 therein. By rotating the optical corner cube 1901, received light 1905 can be reflected off different portions of the off-axis reflective surface 1902 to one of a variety of locations 1908 on an optical element 1904.

In one embodiment, the rotatable optical corner cube 1901 works in conjunction with a polarizing beam splitter 1910. The polarizing beam splitter 1910 is configured to reflect the incoming linearly-polarized light 1905 to the off-axis reflective surface 1902, but permit the orthogonally-polarized reflected light 1906 to pass through to the optical element 1904 where, in one embodiment, the ninety-degrees polarization rotation is achieved thanks to the light 1905 passing twice through a quarter wave plate 1907. The optical axis of the quarter-wave plate 1907 has been aligned to achieve the appropriate amount of polarization rotation.

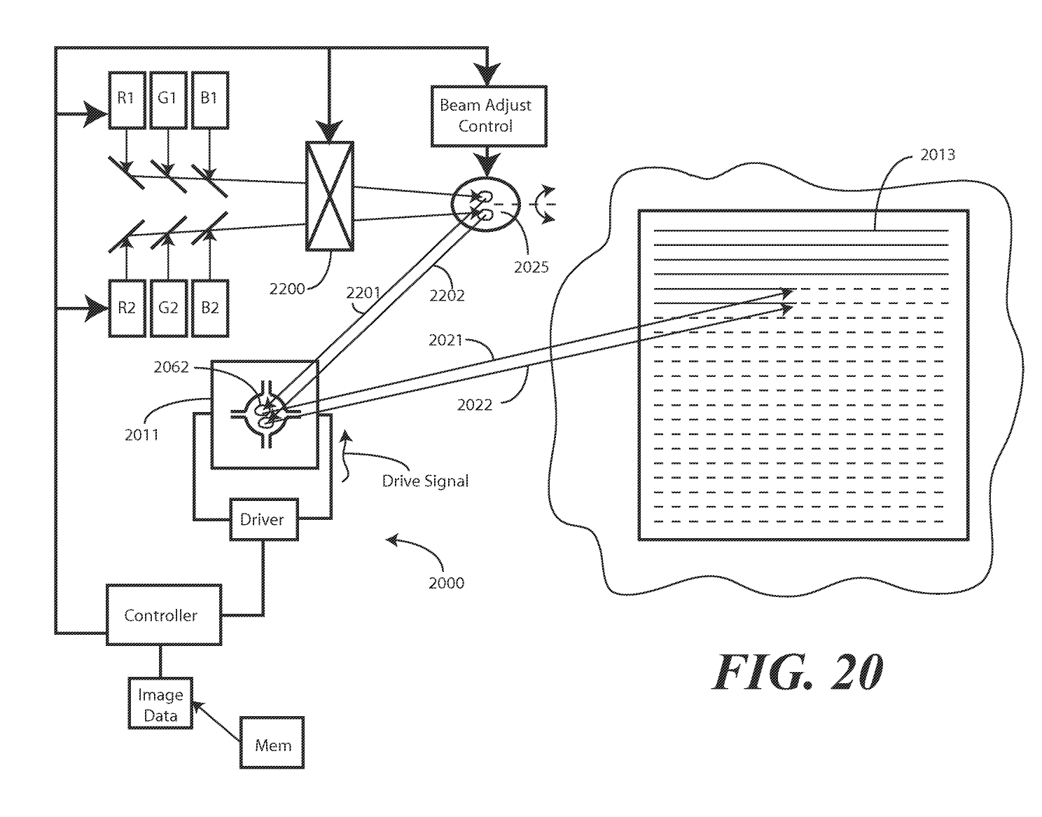

Turning now to FIG. 20, illustrated therein is another imaging system 2000 configured to reduce speckle in accordance with embodiments of the invention. In FIG. 20, a beam shifter 2200 is disposed between the laser sources 2003,2004 and the beam translator 2025. The beam shifter 2200 can take many different forms. Examples of two devices suitable for use as the beam shifter 2200 include the off-center corner cube (1901) of FIG. 19 and the mirror (1602) and polarizing beam splitter (1603) of FIG. 16.

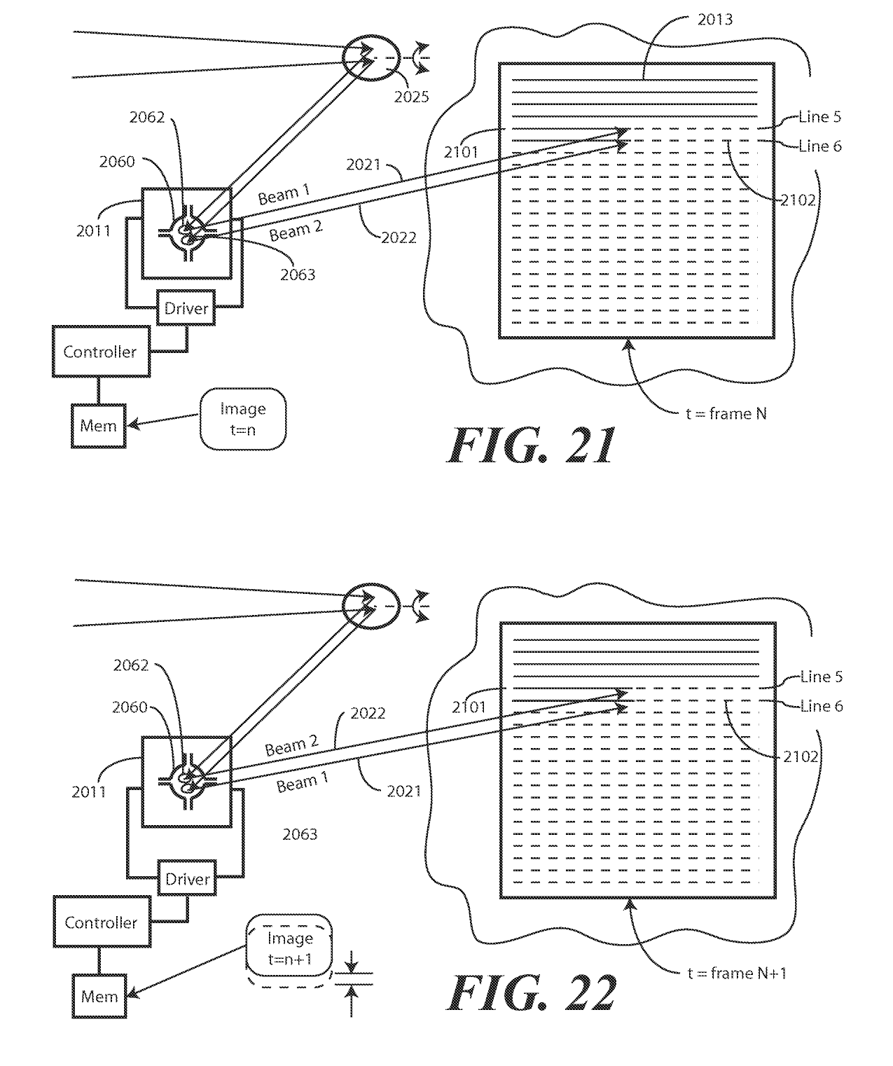

The beam shifter 2200 is configured to cause the two beams 2201,2202 to arrive at a light reception location on the spatial light modulator 2011 on a basis alternating with the successive sweeps of the raster pattern 2013 such that the first beam 2201 at a light reception location 2062 while scanning the one sweep, and the second beam 2202 arrives at that light reception location 2062 while scanning the sequentially subsequent sweep. This is best illustrated graphically, and is shown in FIGS. 21-24.

Beginning with FIG. 21, the beam translator 2025 is positioned such that beam 2021 is scanning odd lines 2101 of the raster pattern 2013 from a first location 2062 on the surface 2060 of the spatial light modulator 2011 during a first sweep. The beam translator 2025 moves between rows of the raster pattern to cause beam 2022 to scan even lines 2002 of the raster pattern 2013. Beam 2022 scans those lines from a second location 2063 on the surface 2060 of the spatial light modulator 2011.

Between sweeps, the beam shifter (2200) switches the two beams 2021,2022 such that at a sequentially subsequent sweep, shown in FIG. 22, beam 2022 scans the odd lines from the first location 2062 on the surface 2060 of the spatial light modulator 2011. Beam 2101 scans the even lines 2102 from the second location 2063.

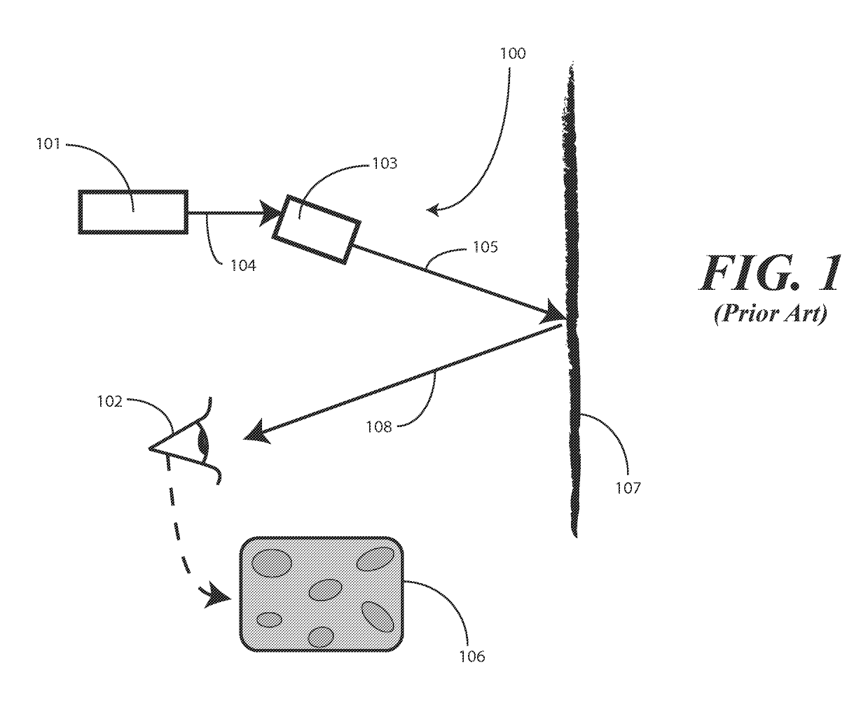

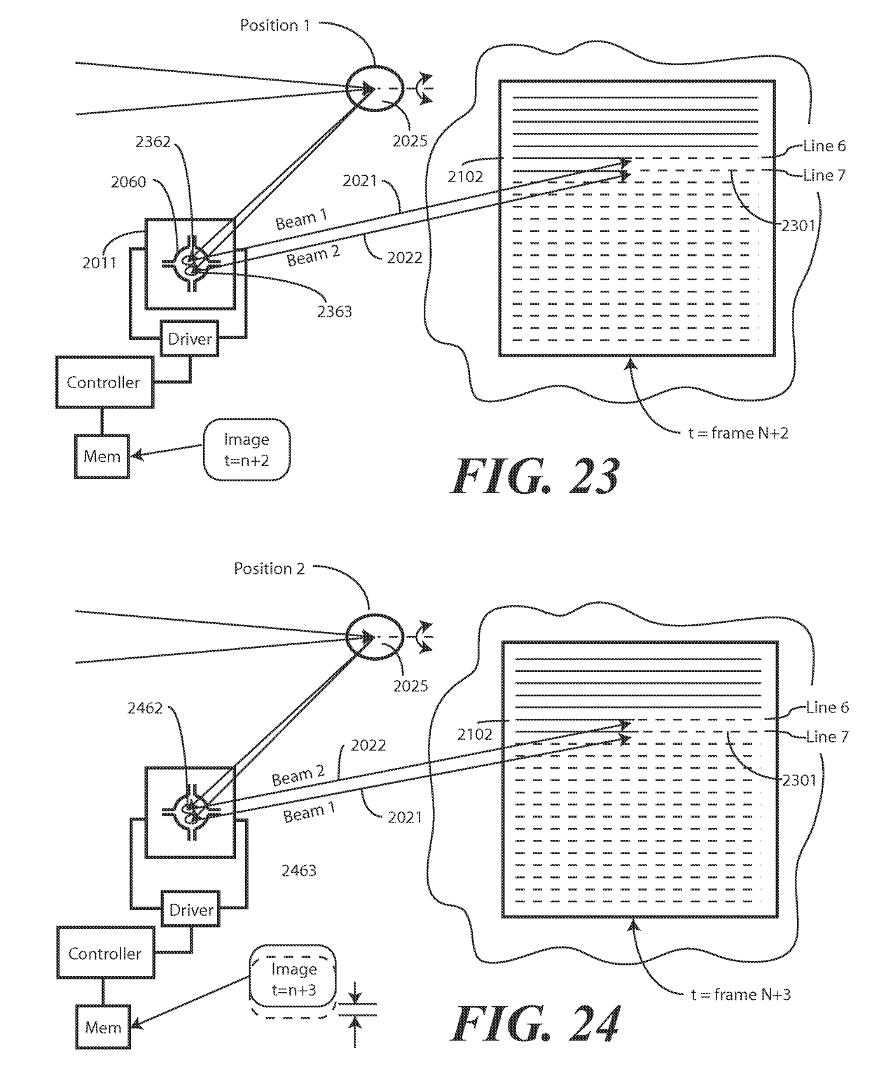

Transitioning to FIG. 23, the beam shifter (2200) switches back to the state of FIG. 21. However, the beam translator 2025 switches such that beam 2021 scans the even lines 2102 and beam 2022 scans the odd lines 2301. Due to the initial offset shown in FIG. 1, transition in state of the beam translator 2025 causes the locations on the surface 2060 of the spatial light modulator 2011 from which the beams 2021,2022 reflect to change as well. Beam 2021 now scans the even lines 2102 from a third location 2362 on the surface 2060 of the spatial light modulator 2111, while beam 2122 scans odd lines 2301 from a fourth location 2363 on the surface 2060 of the spatial light modulator 2111.

In the transition from FIG. 23 to FIG. 24, two things occur: first, the beam translator 2125 toggles back to the state of FIG. 22. Second, the beam shifter (2200) changes state, reversing the beams 2021,2022. Accordingly, as shown in FIG. 24, this results in beam 2021 is scanning odd lines 2301 from a fifth location 2462. The beam translator 2025 moves between rows of the raster pattern to cause beam 2022 to scan even lines 2102 from a sixth location 2463. Experimental testing has shown speckle reduction in this configuration of up to fifty-percent.

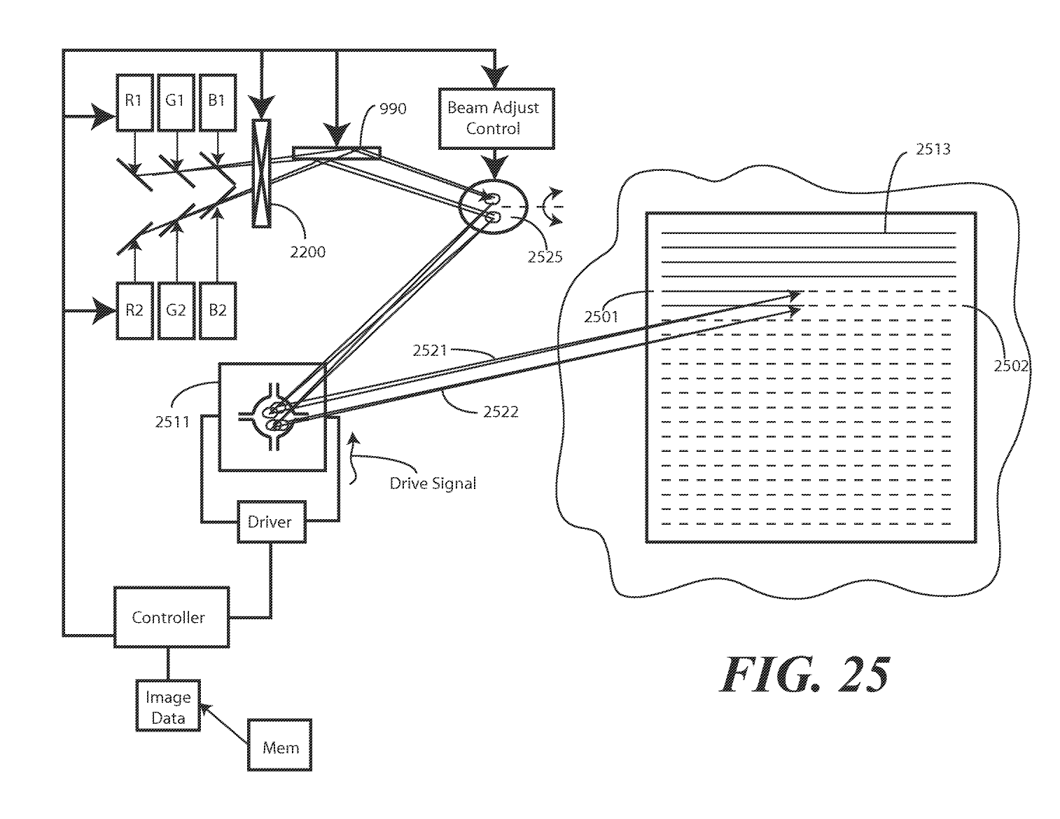

Of course, the embodiment of FIG. 20 and the embodiment of FIG. 9 can be combined, as shown in FIG. 25. In this embodiment, both the beam shifter 2200 and the light translation element 990 are included. With this embodiment, the angular diversity increases further. For example, if a first beam 2521 scans odd lines 2501 of a raster pattern 2513 in a first sweep, any of a variety of things can happen based upon the changes in any of the beam shifter 2200, the light translation element 990 or the beam translator 2525.

In one embodiment, the odd lines 2501 can be scanned by the second beam 2522 in the sequentially subsequent sweep, from either the same or a different location on the spatial light modulator 2511. Next, even lines 2502 of the raster pattern 2513 can scanned by the first beam 2521 a third sweep, from any of a number of locations on the spatial light modulator 2511.

In one alternative embodiment, even lines 2502 of the raster pattern 2513 can be scanned by the first beam 2521 in the sequentially subsequent sweep, with the odd lines 2501 being scanned by the second beam 2522 of the two beams in the third sweep, and so forth. Various other combinations and permutations of light reception location, beam selection, and line selection can be accommodated as well.

As noted above, the various graphical diagrams can be interpreted as steps of a method to reduce speckle in accordance with embodiments of the invention. The method could be configured as executable code for the controllers of the various embodiments. The method includes the steps of adjusting, with a beam translator, which of two beams from a laser source pair a spatial light modulator scans as lines of a raster pattern in successive sweeps of the raster pattern. The adjusting is done such that a line scanned by a first of the two beams in one sweep is scanned by a second of the two beams in a sequentially subsequent sweep. Where an initial offset between beams exists, the method can also include the step of changing a light reception location for each of the two beams between the successive sweeps such that the light reception location for the each of the two beams changes from sweep-to-sweep. Where a beam shifter is included, the method can include shifting the two beams between the successive sweeps such that the two beams to arrive on at a light reception location on the spatial light modulator on a basis alternating with the successive sweeps of the raster pattern. Where other optical elements are included, such as a light translation element, the method can include the step of moving the light reception location for each of the two beams between the successive sweeps such that the light reception location for the each of the two beams changes from sweep-to-sweep. Structures for executing each step have been described above.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An imaging system configured to reduce perceived speckle in images produced by the imaging system, the imaging system comprising:
a plurality of laser sources being configured to produce a plurality of beams of a color;
a spatial light modulator configured to produce the images with light from the plurality of laser sources by scanning the light in a raster pattern along a projection surface;
a beam translator configured to cause lines of successive sweeps of the raster pattern to be scanned with the plurality of beams on an alternatingly shifted basis such that a line scanned by a first of the plurality of beams in one sweep is scanned by a second of the plurality of beams in a sequentially subsequent sweep.

2. The imaging system of claim 1, wherein each of the plurality of laser sources comprises lasers offset from each other such that the first of the plurality of beams and the second of the plurality of beams arrive at the spatial light modulator in different locations.

3. The imaging system of claim 1, wherein the beam translator comprises an electrically moveable mirror.

4. The imaging system of claim 1, wherein a first of the plurality of beams is configured to scan a first portion of the raster pattern in the one sweep and a second portion of the raster pattern in the sequentially subsequent sweep, wherein the first portion and the second portion are different.

5. The imaging system of claim 1, further comprising a beam shifter configured vary an angle of incidence for each of the plurality of beams on a basis alternating with the successive sweeps of the raster pattern.

6. The imaging system of claim 5, wherein the beam shifter comprises an off-axis corner cube.

7. The imaging system of claim 5, wherein the beam shifter comprises a mirror and polarizing beam splitter.

8. The imaging system of claim 5, further comprising a light translation element configured to alter a light reception location between subsequent sweeps of the raster pattern.

9. The imaging system of claim 1, further comprising a light translation element configured to alter a light reception location along the spatial light modulator for one or more of the plurality of beams between subsequent sweeps of the raster pattern.

10. The imaging system of claim 9, wherein the light translation element comprises at least one of an electrically addressable mirror, an electrically addressable phase tilt device, at least two rotating optical wedges, or an off-axis corner cube.

11. The imaging system of claim 1, wherein the spatial light modulator comprises a MEMS scanning mirror.

12. The imaging system of claim 1, wherein odd lines of the raster pattern are scanned by the first of the plurality of beams in the one sweep and even lines of the raster pattern are scanned by the first of the plurality of beams in the sequentially subsequent sweep.

13. The imaging system of claim 1, wherein the imaging system comprises one or more processors configured to control the spatial light modulator in accordance with image data so as to produce the images, wherein the one or more processors are further configured to translate the image data to correspond with movement of the light by the beam translator between the successive sweeps of the raster pattern.

14. The imaging system of claim 13, wherein the one or more processors are configured to translate the image data such that the images generated by the successive sweeps of the raster pattern remain stable on the projection surface.

15. A method in a dual beam laser projection system for reducing speckle in images scanned on a projection surface, comprising:
adjusting, with a beam translator, which of two beams from a laser source pair a spatial light modulator scans as lines of a raster pattern in successive sweeps of the raster pattern such that a line scanned by a first of the two beams in one sweep is scanned by a second of the two beams in a sequentially subsequent sweep.

16. The method of claim 15, further comprising changing a light reception location for each of the two beams between the successive sweeps such that the light reception location for the each of the two beams changes from sweep-to-sweep.

17. The method of claim 15, wherein the two beams between arrive at a common light reception location on the spatial light modulator.

18. The method of claim 15, further comprising moving a light reception location for each of the two beams between the successive sweeps such that the light reception location for the each of the two beams changes from sweep-to-sweep.

19. A laser scanning image system, comprising:
at least one laser source pair;
an electromechanically controllable scanning assembly configured to receive light from the at least one laser source pair and to scan the light in substantially a raster pattern; and
a beam translator configured to cause lines of successive sweeps of the raster pattern to be scanned with two beams from the at least one laser source pair on a changing basis such that two sweeps of any set of consecutive sweeps have at least one line that is scanned by a first of the two beams in one sweep and a second of the two beams in another sweep.

20. The laser scanning image system of claim 19, further comprising a light translation element configured to alter a light reception location along the electromechanically controllable scanning assembly for one or more of the two beams between sequential sweeps of the raster pattern.
